(19) United States
(12) Patent Application Publication
(10) Pub. No.: US 2010/0234508 A1
(43) Pub. Date: Sep. 16, 2010

(54) CARBOXY-MODIFIED POLYVINYL ALCOHOL AS CO-STABILIZER FOR PVC

(75) Inventors: Samuel Michel, Hofheim A Ts (DE); Robert Fuss, Liederbach (DE); Masaki Kato, Okayama (JP); Masato Nakamae, Okayama (JP); Akira Tsuboi, Okayama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KURARAY CO., LTD., Kurashiki-shi (JP)

(21) Appl. No.: 12/669,571

(22) PCT Filed: Jul. 18, 2008
(86) PCT No.: PCT/EP2008/059432

§ 371 Date: Apr. 19, 2010

(30) Foreign Application Priority Data
Jul. 19, 2007 (DE) 102007033971.4

(51) Int. Cl. C08K 5/56

(52) U.S. Cl. 524/399

(57) ABSTRACT

Use of a modified polyvinyl alcohol, obtained by copolymerization of at least on vinyl ester and at least one olefinically unsaturated carboxylic acid or the metal salt, anhydride or ester thereof and subsequent partial saponification of the copolymer as co-stabilizer in thermoplastic processable mixtures based on polyvinyl chloride, containing at least one metal ion stabilizer.

### FIELD OF THE INVENTION

The present invention relates to thermoplastic processable mixtures based on polyvinyl chloride (PVC) which are stabilized with at least one metal ion in combination with carboxyl-modified polyvinyl alcohol.

### BACKGROUND

Thermoplastic processable mixtures based on PVC have to be stabilized against heat and/or UV-radiation in order to reduce chemical decomposition. Especially useful for this purpose are metal ions, for example lead or tin salts or the more eco-friendly calcium or zinc compounds. The metal based stabilizers should have a good dispersibility within the polymer matrix without showing agglomeration or incompatibility during the thermoplastic processing of the PVC-mixture. Furthermore, the stabilizers should not migrate to the surface of the processed material in order to prevent so called “plate-out” or “fish eye” disturbances. Therefore, most stabilizers for PVC contain a plurality of components like polyols, beta diketones, phenolic compounds or inorganic stabilizers. See, for example U.S. Pat. No. 5,143,959.

The use of polyvinyl alcohol (PVA) in metal-based stabilizer mixtures for PVC is known. For example, U.S. Pat. No. 5,118,741 discloses the use of partially hydrolyzed PVA during suspension polymerization of PVC in an amount of 0,5 phr at most and the stabilization of the obtained PVC-mixtures with metal ions. A co-stabilizing effect of the PVA is not mentioned in this publication. Furthermore, the amounts of PVA added are too low to expect any co-stabilizing effect.

DE 272 8 862 discloses a mixture of PVC, and Ca/Zn salts of a β-diketone with PVA as polyol compound without giving any details of the PVA used.

The thermal stability of PVC-mixtures containing PVA as co-stabilizer was further analysed by Ikeda et al. al. in “Polymers and Polymer Composites”, p 649 to 662, vol. 11 no. 8, 2003. This paper shows that non-modified PVA is a suitable co-stabilizer for Zn-stabilized PVC mixtures.

The known PVA-containing stabilizer mixtures for PVC still have deficiencies in view of thermal stability and/or processability during the extrusion of PVC-mixtures.

Surprisingly, it was found that metal ions in combination with polyvinyl alcohols comprising carboxyl groups improve the thermal stability of PVC mixtures and show sufficient compatibility with the polymer matrix.

Without being bound to theory it is assumed that the modified polyvinyl alcohols act as a complex builder for the metal ions.

Therefore, one aspect of the invention are thermoplastic processable mixtures based on polyvinyl chloride comprising at least one metal ion as stabilizer, characterized by the addition of 0,1 to 15 parts per 100 parts of polyvinyl chloride of at least one modified polyvinyl alcohol, obtained by copolymerization of at least on vinyl ester and at least one olefinically unsaturated carboxylic acid or the metal salt, anhydride or ester thereof and subsequent partial saponification of the copolymer.

The modified polyvinyl alcohol may comprise 0.01-5 mol % of at least one olefinically unsaturated carboxylic acid or its derivative.

Suitable olefinically unsaturated carboxylic acids comprise 3 to 20 carbon atoms and may have one or two carboxylic groups. The following derivates can be employed for the production of a modified PVA useful in the present invention:
alkaline or earth alkaline metal salt
intermolecular or intramolecular anhydride
mono- or diester with an alcohol comprising 1 to 20 carbon atoms

By way of example, the modified polyvinyl alcohol may comprise the following repeating units:

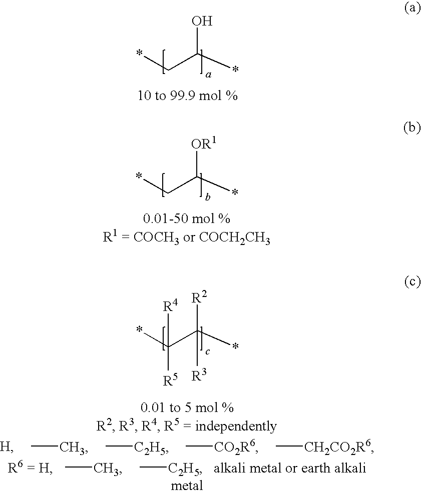

With the provisio that at least one residue R², R³, R⁴, R⁵ contains a carboxylic group

Preferable, the modified polyvinyl alcohol is obtained by copolymerization of vinyl ester like vinyl acetate with at least one monomer selected from the group itaconic acid (R²═CO₂H, R³═CH₂CO₂H, R⁴, R⁵═H), fumaric acid (R², R⁵═CO₂H; R³, R⁴═H), maleic acid (R², R⁴═CO₂H; R³, R⁵═H), crotonic acid (R²═CO₂H; R³, R⁴═H; R⁵═CH₃), citraconic acid (R², R⁴═CO₂H; R³═H; R⁴═CH₃), acrylic acid (R²═CO₂H; R³, R⁴, R⁵═H), methacrylic acid (R²═CO₂H; R³═CH₃; R⁴, R⁵═H), and/or the corresponding methyl esters, ethyl esters, alkali metal salts or earth alkali metal salts, and subsequent saponification of the copolymer.

The copolymerization of said monomers and the hydrolysation conditions are known to the person skilled in PVA chemistry (see, for example JP57-119902).

During copolymerisation, many different orientations of the monomers in the polymer backbone may occur. For sake of clarity, the isomers or stereoisomers were omitted in above formula, but are still within the scope of the invention.

Preferable, the modified polyvinyl alcohols used in the invention do not contain repeating units (c) derived from acrylic or methacrylic acid.

The carboxylic acid groups of repeating unit c may react with adjacent hydroxyl groups to form a respective lactone. This reaction depends on the pH conditions during the saponification conditions, the mixing conditions during the manufacture of the thermoplastic processable mixtures and the compositions thereof. The amount of lactone rings in the modified polyvinyl alcohol does not influence the co stabilizing effect in the PVC mixture.

The modified polyvinyl alcohol may have a degree of hydrolysation (saponification) of at least 60 mol %, preferable 60 to 95 mol % and especially 70 to 85 mol %, based on the original amount of vinyl acetate units.

The degree of polymerization is preferable between 200 and 1500, preferable between 400 and 800.

The mixtures according to the invention contain preferably 0,1 to 5 parts polyvinyl alcohol per 100 parts PVC. Preferably 0,1 to 1 phr, preferably 0,1 to 0,5 phr.

Stabilizer according to the invention is at least one metal ion selected from the group barium, zinc, calcium or tin, especially in the form of the respective organic or inorganic salts. Preferable “metal soaps”, i.e. salts of carbon acids comprising 1 to 25 carbon atoms, especially stearates, laureates, maleates, oleates, or terephthalates or metal salts of acetyl acetonate, mercaptane or β-diketones are used.

Especially useful is a stabilizer mixture derived from zinc and calcium salts, preferably the respective salts of β-diketones, acetyl acetone or carboxylic acids comprising 1 to 25 carbon atoms, preferable in a mixture of 1:1 to 1:4, especially 1:2 parts.

Furthermore, in PVC industry commonly used filling materials for example selected from the group consisting of TiO₂, CaCO₃, ZrO₂, Kaolin, Talcum, K/Al silicates, feldspar, silicate, barium sulphate, metal powder, graphite, calcium sulphate, ceramic and glass particles or wood may be added to the thermoplastic mixture in about 5 to 20 parts per hundred parts of polyvinyl chloride.

The addition of common plasticizers known to the PVC processing industry like dioctyl phthalate, diisononyl phthalate, or their hydrated derivates, dioctyl terephthalates, alkyladipates, alkybenzoates, epoxidised alkyl ester or epoxidised vegetable oils like epoxidised soybean or linseed oil, each in 0,1 to 100 parts per 100 parts PVC is possible.

In the case of plasticizers like epoxidised soybean oil which are also contributing to the thermal stabilisation of the PVC, lower concentration may be employed and it will be added in amounts of about 0,01 to 10 phr of PVC.

Another object of the invention is a process for manufacture of thermoplastic processable mixture based on polyvinyl chloride comprising at least one metal ion as stabilizer comprising 0,1 to 15 parts per 100 parts of polyvinyl chloride of at least one modified polyvinyl alcohol, obtained by copolymerization of at least on vinyl ester and at least one olefinically unsaturated carboxylic acid or the metal salt, anhydride or ester thereof and subsequent partial saponification of the copolymer by mixing the components at a temperature of at least 120° C. for example in an extruder or a kneader.

Preferably, the mixing may be performed prior to or during a thermoplastic form shaping process at about 180 to 240° C.

The optional thermoplastic form shaping process is usually performed with or in an extruder or calender for example by first melting the components during feeding process at said temperatures and afterwards form shaping the mixture at elevated pressure.

The PVA can be added to the PVC as a powder or in form of a solution. This PVA solution can be prepared with water or with any suitable organic solvent (for example ethanol) or any mixture thereof. The metal salts can be added as dry blend or also in form of a solution. Alternatively, all additives can be added alone or together (as “one pack formulation”) to the PVC as dry blend, for example in an extruder, dry mill or kneader.

The use of said polymer comprising the repeating units a)-e) as co-stabilizer in thermoplastic processable mixtures based on PVC containing at least on metal ion as stabilizer is further an object of the present invention.

Depending on the intended use of the thermoplastic mixture, different metal ions in different concentrations may be used.

Typically, PVC mixtures for bottles, tubes or profiles may contain 0,3 to 3 phr tin ions. For flexible PVC mixtures, like plastisoles Ba- and Zn-ions in a total amount of 1 to 3 phr are used. Ca/ZN mixtures in a total amount of 2-3.5 phr are used for floor coverings. Such mixtures and the amounts of metal ions are known in the PVC industry. In cases where epoxidised vegetable oils are employed it may even possible to reduce the amount of PVA and metal ions according to the invention without impairing thermal stabilization.

Thermoplastic processable mixtures according to the invention are especially useful for the production of window or door profiles, films, coatings, sheets, tubes, cables, floorings, bottles, or floor coverings.

### EXAMPLE

Samples comprising the components according to table 1 were prepared by the following steps:
1% of PVA was dissolved in water.
PVC was added to the solution, and then dried at 50° C. for 8 hrs
To the PVC/PVA mixture, DOP (Dioctyl phthalate), Zn-stearate and Ca-stearate were added and dry blended
60 g of the resulting mixture was milled using an open roll at 160° C. for 5 min.

The obtained mixtures were pressed into sheets of 50×70 mm with a thickness of about 0,45 mm. The sheets were then heated to 180° C. in an oven and the whiteness of the heated sheets was measured the room temperature using a colorimeter. The whiteness values show the co-stabilizing effect of the polyvinyl alcohol used.

A differential colorimeter (Model SM-T-H1 colour computer, Suga Shikenki Co., Ltd) with SC-T(P), SM-T(P), ver8.00 software, mounting a specimen holder window 30 mm in diameter was used to measure the whiteness level.

TABLE 1

| | |
|---|---|
| PVC (Shin-Etsu TK1000) | 100 phr |
| DOP | 20 phr |
| Zn stearate (Zn-st) | 2 phr |
| Ca stearate (Ca-st) | 1 phr |
| PVA (co-stabilizer) | 1 phr |

TABLE 2

| | Heating time [min] | | | | | | | |
|---|---|---|---|---|---|---|---|---|
| | 0 | 30 | 45 | 60 | 90 | 105 | 120 | 135 |
| | Whiteness values | | | | | | | |
| Ex 1 | 92.6 | 92.6 | 92.6 | 85.7 | 83.3 | 84.6 | 23.4 | 20.8 |
| Comp. Ex | 92.3 | 91.2 | 89.5 | 87.1 | 82.8 | 61.4 | 0 | 0 |

The PVA were produced as follows:

### Example-1

### Preparation of Carboxyl Group Modified Polyvinyl Alcohol

Vinyl acetate (1200 parts), methanol (1800 parts), 20 wt % of Itaconic acid (IA) methanol solution (3 parts) and azobisisobutyronitrile (1.5 parts) were fed into a polymerization vessel equipped with a reflux condenser and an agitator. 20 wt % of IA methanol solution was added continuously at a rate of 15 mL/hr. Polymerization was conducted for 4.5 hours (polymerization conversion 65%) while stirring under a nitrogen stream at 60° C. Unreacted vinyl acetate was removed to give a methanol solution (resin content 40%) of the polymer. This solution was fed into a reactor. Sodium hydroxide (5 mmol per vinyl acetate unit in the polymer) was added thereto to conduct hydrolysis at 40° C. Generated polyvinyl alcohol gel was milled and washed thoroughly with methanol and dried in a hot air dryer to give IA modified polyvinyl alcohol resin.

Degree of hydrolysis and degree of polymerization were measured in the same manner as described at JIS K6726. Degree of hydrolysis was 74 mol %. Degree of polymerization was 550. Degree of IA modification was measured by ¹H-NMR. Degree of IA modification was 1 mol %. The PVA has the following composition with regard to the repeating units a)-c):

74 mol % of unit a), 26 mol % of unit b) 1 mol % of unit c) (R²═CO₂H, R³═CH₂CO₂H, R⁴, R⁵═H).

### Comparative Example

### Preparation of Unmodified Polyvinyl Alcohol

Vinyl acetate (1200 parts), methanol (1800 parts) and azobisisobutyronitrile (1.5 parts) were fed into a polymerization vessel equipped with a reflux condenser and an agitator. Polymerization was conducted for 4.5 hours (polymerization conversion 65%) while stirring under a nitrogen stream at 60° C. Unreacted vinyl acetate was removed to give a methanol solution (resin content 40%) of the polymer. This solution was fed into a reactor. Sodium hydroxide (5 mmol per vinyl acetate unit in the polymer) was added thereto to conduct hydrolysis at 40° C. Generated polyvinyl alcohol gel was milled and washed thoroughly with methanol and dried in a hot air dryer to give polyvinyl alcohol resin.

Degree of hydrolysis and degree of polymerization were measured in the same manner as described at JIS K6726. Degree of hydrolysis was 74 mol %. Degree of polymerization was 550.

As can be seen from table 2, modified polyvinyl alcohol according to the invention has an improved stabilizing effect as compared to non-modified polyvinyl alcohols.

1. A thermoplastic processable mixture based on polyvinyl chloride comprising at least one metal ion as stabilizer, wherein the mixture comprised the addition of 0.1 to 15 parts per 100 parts of polyvinyl chloride of at least one modified polyvinyl alcohol, obtained by copolymerization of at least one vinyl ester and at least one olefinically unsaturated carboxylic acid or the metal salt, anhydride or ester thereof and subsequent partial saponification of the copolymer.

2. The thermoplastic processable mixture according to claim 1, wherein the modified polyvinyl alcohol comprises 0.01-5 mol % of at least one olefinically unsaturated carboxylic acid or the metal salt, anhydride or ester thereof.

3. The thermoplastic processable mixture according to claim 1, wherein the modified polyvinyl alcohol comprises 0.01-5 mol % of at least one olefinically unsaturated carboxylic acid with 3 to 20 carbon atoms, the alkaline or alkaline earth metal salt, the anhydride or an ester with a alcohol comprising 1 to 20 carbon atoms thereof.

4. The thermoplastic processable mixture according to claim 1, wherein the modified polyvinyl alcohol is obtained by copolymerization of vinyl acetate with at least one monomer selected from the group consisting of itaconic acid, fumaric acid, maleic acid, crotonic acid, citraconic acid, acrylic acid, methacrylic acid, and corresponding esters and metal salts, and subsequent saponification.

5. The thermoplastic processable mixture according to claim 1, wherein the modified polyvinyl alcohol has a degree of saponification of at least 60 Mol %.

6. The thermoplastic processable mixture according to claim 1, wherein the modified polyvinyl alcohol has a degree of polymerization of 200 to 1500.

7. The thermoplastic processable mixture according to claim 1, wherein at least one metal ion selected from the group consisting of barium, zinc, calcium and tin is used as stabilizer.

8. The thermoplastic processable mixture according to claim 1, wherein a mixture of zinc and calcium salts of a carboxylic acid comprising 1 to 25 carbon atoms, acetyl acetone or β-diketone is used as stabilizer.

9. The thermoplastic processable mixture according to claim 1, wherein the mixture contains 5 to 20 parts per 100 parts of polyvinyl chloride of a filler material selected from the group consisting of TiO₂, CaCO₃, ZrO₂, kaolin, talcum, K/A1 silicates, feldspar, silicate, barium sulphate, metal powder, graphite, calcium sulphate, ceramic and glass particles or wood.

10. A process for the production of the thermoplastic processable mixtures according to claim 1 by mixing the components at a temperature of least 120° C.

11. The process according to claim 10 wherein the mixing is obtained during a thermoplastic form shaping process at 180 to 240° C.
